(19) United States
(12) Patent Application Publication
(10) Pub. No.: US 2010/0050257 A1
(43) Pub. Date: Feb. 25, 2010

(54) CONFIRMATION METHOD OF API BY THE INFORMATION AT CALL-STACK

(76) Inventor: Kyung Sub Jin, Euijungbu-Si Gyeonggi-Do (KR)

Correspondence Address: IPLA P.A., 3550 WILSHIRE BLVD., 17TH FLOOR, LOS ANGELES, CA, 90010, US

(21) Appl. No.: 12/514,044

(22) PCT Filed: Nov. 7, 2007
(86) PCT No.: PCT/KR07/05604

§ 371 Date: May 7, 2009

(30) Foreign Application Priority Data
Nov. 7, 2006 (KR) 10-2006-0109707

(51) Int. Cl. G06F 11/00

(52) U.S. Cl. 726/22

(57) ABSTRACT

The present invention relates to a method of verifying an API using information recorded in the call stack. In the API verification method, whether at least one application is executed is determined in a system in which the application is installed. An API function requested when the application is executed is hooked. Details of a call stack for the API function are output. A stack Database (DB), in which call stack details for various types of API functions required for operation of the application are stored, is searched for the output call stack details, and the output call stack details are checked.

### TECHNICAL FIELD

The present invention relates to a method of verifying an API using information recorded in a call stack.

### BACKGROUND ART

As well known to those skilled in the art, a stack denotes a data storage unit or a buffer for storing requests to be processed, and is described in IBM's computer dictionary as a push-down list. This means that requests previous to a new request are pushed down when the new request is received. Therefore, a stack is operated in a Last-In, First-Out (LIFO) manner.

A call stack is configured to record details, such as the return address of a calling function or parameters, according to LIFO rules when the execution of a function is requested via an Application Program Interface (API) function requested by a process, and to return to a return address stored in the stack and continue a task when a called function is terminated.

Meanwhile, in a system environment in which various types of applications are installed, when a management or security program (hereinafter collectively referred to as a ‘management program’) capable of executing the control and security of the applications is produced, it is necessary to work in close cooperation with given applications. However, in the case of each application, since a developer who develops the application generally does not open program code or the like to the public so as to protect the technology thereof, and a third party also has limited ability to analyze the configuration of the application, it is difficult for the third party to produce and configure management programs that work in close cooperation with various types of applications.

Such difficulty leads to the use of invasion programs (hacking programs, viruses, etc.),having configuration and execution methods similar to those of the management programs, to execute unauthorized tasks in a system while avoiding the monitoring of the management programs, thus limiting the ability of the management programs to strictly manage the system.

Meanwhile, the most general method used by such a management program to work in cooperation with an application includes a method of hooking and controlling a specific API function used by the application. Such a method is performed by permitting or prohibiting the execution of an existing API function, or by replacing an existing API function with the API function of a management program.

In the case of a conventional management program, respective functions must be classified for the purpose of the control of an API function, and such a classification method is performed by checking the parameters of functions. However, such a classification method is problematic in that it is difficult to classify API functions that perform the same behavior for different purposes (authorized execution and unauthorized execution for invasion or hacking).

That is, when the environment file of an application is changed, the parameters of API functions that are respectively used in the case (1) where changes are normally made using the environment file change program of the application itself and the case (2) where a user arbitrarily creates an environment file and overwrite the created file on a previous file are identical to each other. Accordingly, it is impossible to classify the fundamental purposes and usages of called API functions using the conventional management program.

This problem must be urgently solved because the management program has a limitation in its ability to strictly manage applications while working in cooperation with the applications.

### DISCLOSURE OF INVENTION

### Technical Problem

Accordingly, the present invention has been made keeping in mind the above problems occurring in the prior art, and an object of the present invention is to provide a method of verifying an API using information recorded in a call stack, which can check information that is a basis for the execution of a management program and exists out of the range under the control of an invasion program, thus safely performing efficient and reliable management of a system.

### Technical Solution

In order to accomplish the above object, the present invention provides a method of verifying an Application Program Interface (API) using information recorded in a stack, comprising determining whether at least one application is executed in a system in which the application is installed; hooking an API function requested when the application is executed; outputting details of a call stack for the API function; and searching a stack Database (DB), in which call stack details for various types of API functions required for operation of the application are stored, for the output call stack details and checking the output call stack details.

### Advantageous Effects

According to the present invention, a system precisely determines whether a task executed by an arbitrary application is authorized or unauthorized by checking the execution request details of an API function. Accordingly, even if the configuration of an application is not precisely analyzed, or if the operation format of the application in a system is not fully understood, negative operations performed in the application can be more precisely controlled, and the operation of the application in the system can be stably managed, thus preventing the operation of various types of invasion programs, which access the system through a variety of methods.

### BRIEF DESCRIPTION OF THE DRAWINGS

FIG. 1 is a flowchart showing the operation flow of a method of verifying an API according to the present invention;

FIG. 2 is a block diagram showing a process for verifying an API in a system according to the present invention; and

FIG. 3 is a diagram conceptually showing the structure of a stack.

### MODE FOR THE INVENTION

Hereinafter, embodiments of the present invention will be described in detail with reference to the attached drawings.

The term ‘stack’ means a data storage unit or a buffer in which requests to be processed are stored,and in which requested data is recorded in an LIFO manner and is inserted or deleted through the top of the stack. Such data includes the execution request details of an Application Program Interface (API) function which is required to perform the logic of an Operating System (OS) or various types of applications. The API verification method according to the present invention can read the execution request details of the API function, recorded in the stack, from the stack, and can determine the purpose of a function currently being executed by the system (computer), or can determine whether the function currently being executed is an unauthorized function.

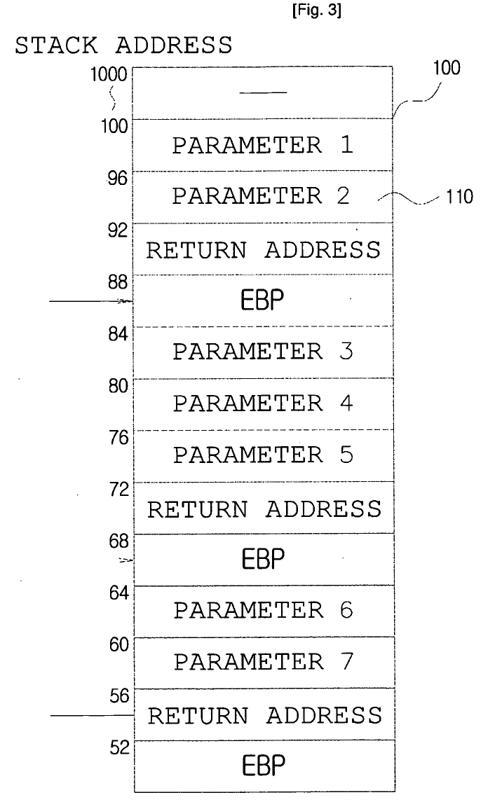

FIG. 3 is a diagram conceptually showing the structure of a stack. A description is made with reference to FIG. 3.

A stack 100 is placed in memory included in a processor, and is typically divided into areas 110, each having 4 bytes.

When a function is called through manipulation by a user, the processor requires recording to normally execute the called function, and such recording is sequentially left in the areas 110 of the stack 100.

As well known to those skilled in the art, Last Input, First Output (LIFO) is a method in which the last command or function input to the stack is processed first, and thus the stack 100 is also operated in such a sequence. Therefore, details to be recorded in the areas 110 are recorded in the sequence from the top to the bottom of the stack 100, and operation is performed in the sequence from the bottom to the top. Further, each area 110 to be checked by the processor for the next operation is checked with reference to a return address.

For reference, since each area 110 of the stack 100 has a unique address, and a unique address is described as a return address, the operation flow of the processor can be traced by finding an address recorded as the return address.

Meanwhile, an Extended Base Pointer (EBP) is configured to define the boundary of an operation to be performed by the processor, and is implemented such that the return address is recorded in an area previous to (upper area) the EBP area according to the rules.

(Reference Data 1)

```
  PowerPoint <dwDesiredAccess 80000000>, <dwCreationDisposition
  00000003>
file Name =
C:\DOCUME~1\ALLUSE~1\APPLIC~1\MICROS~1\Office\
Data\DATA.BAK
  Stack =
  011B0000 C:\Product\bin\vsd\vsdpwpnt.dll
  +00005E1A (3A43, 80000000, 1, 3, 1)
  7C800000 C:\WINDOWS\system32\kernel32.dll
  +00027757 (13CF00, 80000000, 1, 0, 3)
  +00027B6B (13CF00, 13D300, 0, 0, 0)
  011B0000 C:\Product\bin\vsd\vsdpwpnt.dll
  +000033E4 (13CF00, 13D300, 0, 0, 0)
  7C800000 C:\WINDOWS\system32\kernel32.dll
  +0002872E (7FFDDC00, 18B430, 0, 0, 0)
  30B00000 C:\Program Files\Common Files\Microsoft Shared\
  office10\mso.dll
  +00035963 (13DD64, 13DE68, 1, 118, F50010)
  +00035644 (13ED7C, 4, 8, F50010, 0)
  +00034E04 (30BC05BC, 30B61F9F, 30B61B3E, F2015C, F201EC)
  +0006061E (0, FFFFFFFE, 0, 13EE58, 4A)
```

(Reference Data 2)

```
  PowerPoint <dwDesiredAccess 80000000>, <dwCreationDisposition
  00000001>
file Name = C:\data.bak
  Stack =
  011B0000 C:\Product\bin\vsd\vsdpwpnt.dll
  +00005E1A (3A43, 80000000, 0, 1, 1)
  30B00000 C:\Program Files\Common Files\Microsoft Shared\
  office10\mso.dll
  +00028A45 (1367FC, 80000000, 0, 0, 1)
  +0017963C (1367FC, 80000000, 0, 0, 1)
  +00179F1C (1367FC, 0, 0, 0, 392005C)
  +0017A82B (1367FC, 0, 3929AAC, 0, FFFFFFFF)
  +00118401 (25, 25, 0, 3929AAC, 136D78)
  +000416CC (3, 25, 25, 0, 0)
  +000FDF82 (0, 3, 25, 0, 25)
  +000FE12E (1, 0, 4, 3928AAC, 136E08)
  +00088DB8 (3928AAC, 8001, 0, 0, 3928AAC)
  +0008D53D (3928AAC, 8001, 0, 0, 0)
  +0008D493 (1240201, 4, 0, 136FC8, 3928AAC)
  +00088DB8 (3928AAC, 4, 0, 136FC8, 4)
  +000FE5C9 (3928AAC, 4, 0, 136FC8, 77CFC505)
  +0008987F (4, 0, 136FC8, 13701C, 30B40387)
  77CF0000 C:\WINDOWS\system32\USER32.dll
  +00008734 (1407FE, 202, 0, 1240201, 30B40387)
  +00008816 (30B40387, 1407FE, 202, 0, 1240201)
  +000089CD (0, 30B40387, 1407FE, 202, 0)
  +00008A10 (1370EC, 0, 10000000, 30B884E2, 1370EC)
  30B00000 C:\Program Files\Common Files\Microsoft Shared\
  office10\mso.dll
  +000884E2 (1370EC, 800000, 137110, 0, 1)
```

The reference data 1 indicates execution request details recorded in a call stack when PowerPoint (an application produced by Microsoft Corporation) automatically creates a data.bak file (backup file) for a PowerPoint file ‘*.ppt’. The reference data 2 indicates execution request details recorded in a call stack when the user arbitrarily stores a PowerPoint file ‘*.ppt’ as a file having a file extension ‘*.bak’. Therefore, even when the final results of execution are identical to each other, the execution request details of API functions, recorded in the stack, differ. Therefore, the reason for calling the API function can be presumed or determined by comparing these differences with each other.

The reference data 1 and the reference data 2 denote call stacks obtained by hooking API functions for storing files in an environment in which setting is performed to store a data.bak file in any location, and make it obvious that, even if the same results are obtained, execution request details recorded in a call stack differ from each other under different conditions (a condition in which PowerPoint automatically stores a file and a condition in which the user arbitrarily stores a file as desired).

Of course, when PowerPoint performs a procedure for automatically storing a file, call stacks for the API function are the same even if this procedure is repeated several times.

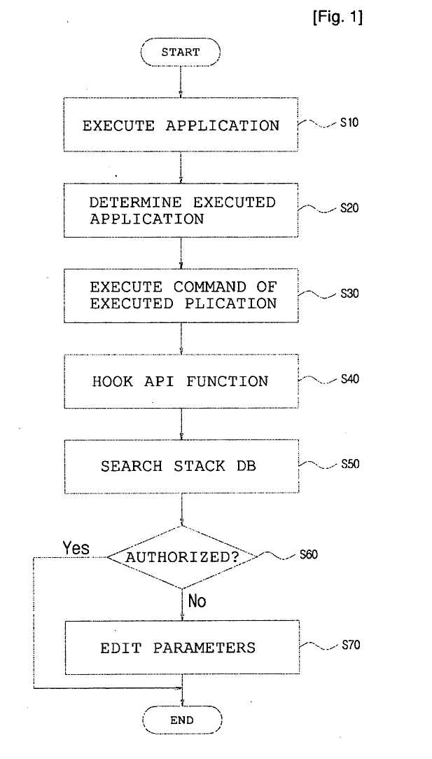

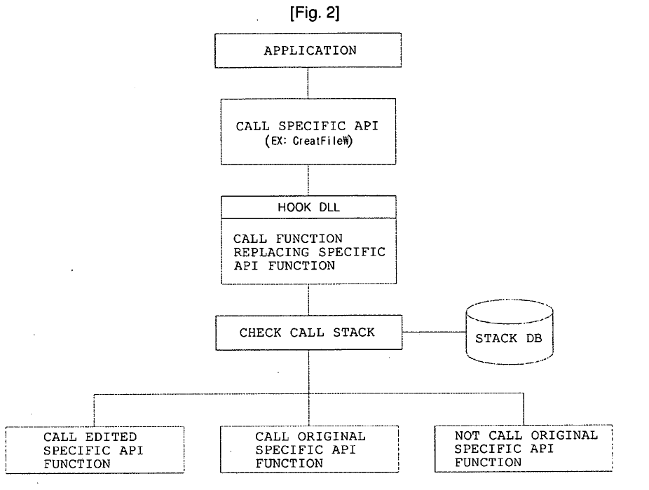

FIG. 1 is a flowchart showing the operation flow of a method of verifying an API according to the present invention, and FIG. 2 is a block diagram showing a process for verifying an API in a system according to the present invention. The present invention is described with reference to the drawings.

A process in which a plurality of applications is operated can be more precisely verified and managed in a system in which the applications are installed using the API verification method of the present invention. The running of an unauthorized system and erroneous operation, attributable to various types of invasion programs, can be prevented through such a process.

FIG. 1 illustrates steps including up to an application step to which the API verification method of the present invention is applied. The API verification method of the present invention is described according to respective steps so as to describe embodiments of the present invention in detail.

S10; Application Execution Step

A management device that uses and applies the API verification method according to the present invention determines whether an application activated by a target system is executed.

That is, when the user activates an application required to perform an arbitrary subject in the system, the system transmits data, indicating that the application is executed, to the management device while executing the application.

S20; Executed Application Determination Step

The management device checks the application currently being executed, and determines whether the application is an application that is registered to be managed.

In the case of call stacks of API functions, even if the API functions are the same, execution request details to be strung vary according to the type of application. Accordingly, references to be applied (the form of execution request details, such as reference data 1 and reference data 2) must be differently selected/applied according to the type of application. Therefore, when an arbitrary application is executed in the system, whether the application is registered in the management device and is thus set to be managed must be determined.

S30; Executed Application Command Execution Step

Once the executed application is determined to be a management target application, which is to be managed by the management device, the management device checks, in real time, an API function requested by the application while the application is being executed, in response to a command provided by the user or the system.

For example, when the application is ‘Hangul’, which is a kind of word processing program, and a user attempts to store a created document file using ‘Hangul’, the system or the application ‘Hangul’ requests an API function required for storage, and the API function is checked by the system.

Referring to FIG. 2, the application calls a specific API function corresponding to a given command so as to execute the command.

S40; API Function Hooking Step

Whether the API function checked at the executed application command execution step is an API function that is registered to be managed is determined.

For this determination, a given operation is temporarily stopped through a hooking operation, and an arbitrary function is called. As shown in FIG. 3, when an arbitrary function F (parameter 6 and parameter 7) is called, recording related to the calling of the function is left in the stack 100. In this case, the address of the parameter 7 is checked, and the exact area 110 in which the parameter 7 is located is detected in the stack 100. Generally, the address or location of the area 110 can be checked through a command (& parameter 7) written in C language.

When the location of the parameter 7 in the stack 100 is detected, EBP is found in the stack 100, in which recording is performed according to rules, on the basis of the location of the parameter 7.

Next, since the area immediately above the area of the EBP is an area in which an address, to which the previously called function is returned at the time of termination, is recorded, the return address can be checked through the area immediately above the EBP. Meanwhile, the content (value) of EBP indicates the address of the EBP value of a function, which previously called the EBP. Of course, since the area previous to the previous EBP area indicates the EBP of the call function previous to the previously called function, the procedure is repeated, and thus the recording of return addresses of all called functions in the stack 100 can be traced at the time of executing the API function that is registered to be managed.

As described above, the results of the tracing indicate the details of the reference data 1 and the reference data 2.

Meanwhile, an application requires a plurality of API functions for the execution thereof. In the API functions, functions that are not required in order to manage the application are also included. However, the management device is mainly used to secure and manage the information stored in the system in the form of files, and thus API functions required to copy or move files can be main targets to be traced by the management device.

However, the targets traced by the management device are not limited to API functions required to copy or move files.

Next, when a requested API function is determined to be an API function registered to be managed, the API function is hooked, and the execution request details of the API function are output. In this case, the execution request details of the API function may have the format of the reference data 1 or the reference data 2.

Referring to FIG. 2, the management device calls a function of replacing the previously requested API function while performing hooking. That is, the system or application normally calls an API function, but the management device is provided with an API function that replaces such a normal API function, so that errors can be prevented from occurring in the processing of the system, and the subsequent task can be performed.

S50; Stack DB Search Step

The management device includes a stack DB in which the execution request details of respective applications and API functions are stored.

As described above, since the execution request details of the same API function under the same conditions are identical to each other, the execution request details of API functions corresponding to various types of tasks executed in an arbitrary application are checked, and are stored in the form of data.

That is, the execution request details of the call stack, obtained when PowerPoint automatically stores a file, as shown in the reference data 1, are checked, and are stored in the stack DB in the form of text or an image. Thereafter, the execution request details, checked when a task for storing the file is performed in PowerPoint, are compared with the execution request details, which are stored in the stack DB and which correspond to the checked execution request details, and thus identicalness or difference therebetween is verified.

In this case, the execution request details of the API function, stored in the call stack, may include directory information about the location at which the task of the API function is performed (for example:
C:DOCUME˜1\ALLUSE˜1\APPLIC˜1\MICROS˜1\Office\Data\DATA.BAK), a Dynamic Link Library (DLL) address represented by an eight-digit character composed of numerals and alphabet letters (for example, ‘011B0000’, ‘7C800000’, etc.), a function return address (+00005E1A, +00027757, +00027B6B, etc.), a DLL file having various types of information required to execute the API function, the location of the DLL (for example, C:\Product\bin\vsd\vsdpwpnt.dll, etc.), and respective parameters (for example, [3A43, 80000000, 1, 3, 1], [13CF00, 80000000, 1, 0, 3], etc.).

In this case, since the parameters are variables, they can be changed, but the function return address is not changed in the case of the execution of the same task in the same environment, and thus the execution request details of the API function can be compared on the basis of the function return address.

For reference, the DLL address, the directory information, the DLL file, and the location of the DLL file are not actually recorded in the stack, but are edited and output by an apparatus for performing the API verification method using information recorded in a call stack according to the present invention.

S60; Authorization Determination Step

Since the stack DB stores execution request details of an API function for an authorized task, the execution request details of the call stack hooked at the API function hooking step S40 are compared with the execution request details of a related API function, stored in the stack DB, and thus whether they are identical to each other is determined.

Generally, the configuration of execution request details for an authorized API function can be detected by individually checking the execution request details, and most execution request details of API functions, attributable to invasion programs or unknown illegal methods, are unknown. Therefore, when the execution request details of an API function, which are not stored in the stack DB, are detected at the API function hooking step S40, the management device considers the operation of the API function currently being executed to be an unauthorized operation. Further, when it is determined that the execution request details of the API function are stored in the stack DB, the operation of the API function currently being executed is considered to be an authorized operation.

Of course, in order to prevent only the operation of a specific invasion program, it is also possible to compare the execution request details of the API function of the invasion program with the execution request details of an API function currently being executed while storing the execution request details of the API function of the invasion program in the stack DB, and to prohibit the execution request details of the API function if identicalness therebetween is determined.

Therefore, even if the execution request details detected at the API function hooking step S40 are identical to the execution request details stored in the stack DB, the determined execution request details are not necessarily considered to be those of an authorized operation.

However, in the embodiment of the present invention, when the execution request details of the API function, which are not present in the stack DB, are detected at the API function hooking step S40, a corresponding operation is determined to be an unauthorized. Therefore, when it is determined at the authorization determination step S60 that the execution request details of the API function stored in the stack DB are identical to the execution request details of the API function detected at the API function hooking step S40, the corresponding operation is considered to be authorized. Further, when the same execution request details are not detected in the stack DB, the corresponding operation is considered to be unauthorized, and thus subsequent operation is performed.

S70; Parameter Editing Step

When it is determined at the authorization determination step S60 that the corresponding operation is unauthorized, execution parameters for the API function related to the corresponding operation are revised in order to prevent the same operation from being repeated, so that a bug is caused in normal operation due to the revision of parameters when the API function is called to subsequently perform the same operation, thus preventing the subsequent procedure from being performed.

Referring to FIG. 2, it is also possible to fundamentally prevent a corresponding operation itself from occurring without providing a normal specific API function requested by the system or application, in addition to the method of preventing the system or the application from being normally operated by editing the parameters for the API function even if the corresponding operation is determined to be an unauthorized operation.

Of course, when the corresponding operation is determined to be authorized at the authorization determination step S60, a normal specific API function, instead of the API function replaced in the above procedure, is provided.

1. A method of verifying an Application Program Interface (API) using information recorded in a stack, comprising:
determining whether at least one application is executed in a system in which the application is installed;
hooking an API function requested when the application is executed;
outputting details of a call stack for the API function; and
searching a stack Database (DB), in which call stack details for various types of API functions required for operation of the application are stored, for the output call stack details and checking the output call stack details.

2. The method according to claim 1, further comprising, if the API function requested for execution of the application is hooked, calling another API function, which replaces the API function, and preventing an error from occurring in the system.

3. The method according to claim 1, further comprising, if it is determined that the call stack details for the API function are authorized as a result of the search of the stack DB, performing a normal operation for the API function, whereas if it is determined that the call stack details are unauthorized, preventing the API function from being called, or editing parameters of the API function and preventing a normal operation from being performed.

4. The method according to claim 2, further comprising, if it is determined that the call stack details for the API function are authorized as a result of the search of the stack DB, performing a normal operation for the API function, whereas if it is determined that the call stack details are unauthorized, preventing the API function from being called, or editing parameters of the API function and preventing a normal operation from being performed.
